(19) United States
(12) Patent Application Publication
(10) Pub. No.: US 2006/0180436 A1
(43) Pub. Date: Aug. 17, 2006

(54) Side discharge conveyor

(75) Inventors: Gary Heeszel, Eugene, OR (US); Tom Furrer, Eugene, OR (US); Benjamin J. Boyce, Eugene, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Johnson Crushers International

(21) Appl. No.: 11/048,988

(22) Filed: Feb. 1, 2005

(51) Int. Cl. B65G 21/10

(52) U.S. Cl. 198/587

(57) ABSTRACT

A folding conveyor for an aggregate/rock processing unit including a frame adapted to allow an outer section of the conveyor to fold from an operational position to a travel position.

### FIELD OF THE INVENTION

Embodiments of the present invention relate to rock and aggregate processing equipment, and more particularly to side folding discharge conveyors for such processing equipment.

### BACKGROUND

Aggregate processing equipment, such as rock screens for size separating aggregate material, and rock crushers for size reducing aggregate material, are typically in communication with and/or use a number of conveyors to move material to discrete locations. Such conveyors may include, but are not limited to, feed conveyors and discharge conveyors.

Often, it may be desirable for the processing units to be mobile, such that they may be transported from one location to another. These mobile units may be mounted, for example, on tracks, wheels, or otherwise adapted for transport. Accordingly, for transport many of the conveyors, such as the side discharge conveyors, must be either removed or folded such that they do not cause the processing unit to exceed certain width restrictions when in the transport configuration.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates a perspective view of an example mobile rock processing unit in accordance with an embodiment of the present invention;

FIGS. 2A and 2B illustrate enlarged perspective views of a folding conveyor in accordance with embodiments of the present invention;

FIG. 3 illustrates an exploded plan view of a folding conveyor in accordance with embodiments of the present invention; and

FIGS. 4A-4C illustrate end views of an example mobile rock processing unit in accordance with embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

The following description may include terms such as inner, outer, under, between, upward, downward, outward, inward, and the like. Such terms are used for descriptive purposes only and are not to be construed as limiting. That is, these terms are terms that are relative only to a point of reference and are not meant to be interpreted as limitations but are, instead, included in the following description to facilitate understanding of the various aspects of the invention.

Embodiments of the present invention may be directed to folding conveyors for rock processing units, such as screens and crushers, to allow the conveyors to be positioned in a travel configuration. In some embodiments, a substantially laterally folding conveyor is disclosed that may allow a processing conveyor protruding from the processing unit, such as a side discharge conveyor, to fold in a substantially lateral fashion in either a forward or rearward direction. Embodiments of the present invention may also allow controlled pivotal movement of an outer section of the conveyor. Embodiments of the present invention may also help reduce the number of components necessary to enable folding, while providing substantial support for the conveyor in both the operational/extended position and the folded/travel configuration.

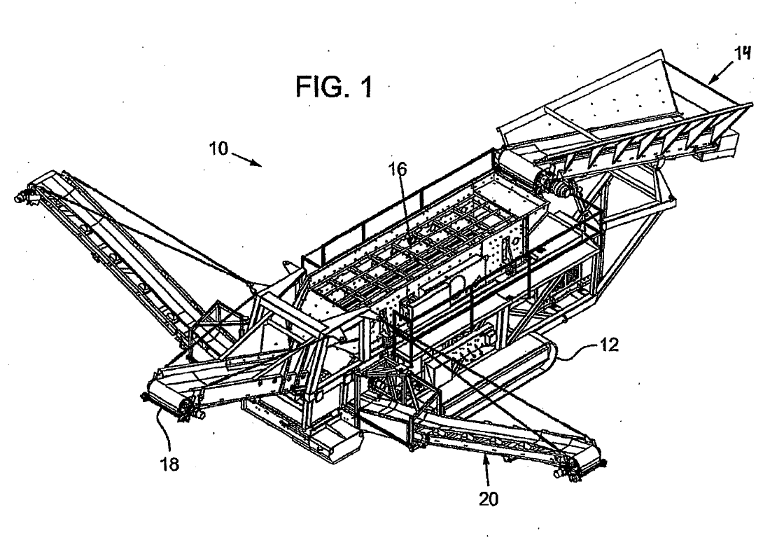

FIG. 1 illustrates a perspective view of an example rock/aggregate processing unit in accordance with an embodiment of the present invention. A mobile processing unit 10 may be configured for transport by being mounted, for example, on a set of tracks 12, and configured to process rock. In other embodiments, the mobile processing unit may be mounted on wheels, or otherwise adapted for transport. Mobile processing unit 10 may include a feed conveyor 14 that conveys material to be size-sorted to a plurality of screen decks 16. Aggregate material from a particular screen deck may be discharged onto an end discharge conveyor 18 or a side discharge conveyor 20 such that it can be transported to a discrete location, such as another processing unit, stockpile or stockpiling conveyor (not shown). As illustrated, the side discharge conveyor 20 is in the operational configuration, such that it is protruding generally outward from the mobile processing unit 10. Embodiments of the present invention may be used with a variety of conveyors in communication with the mobile processing units, not only side discharge conveyors 20.

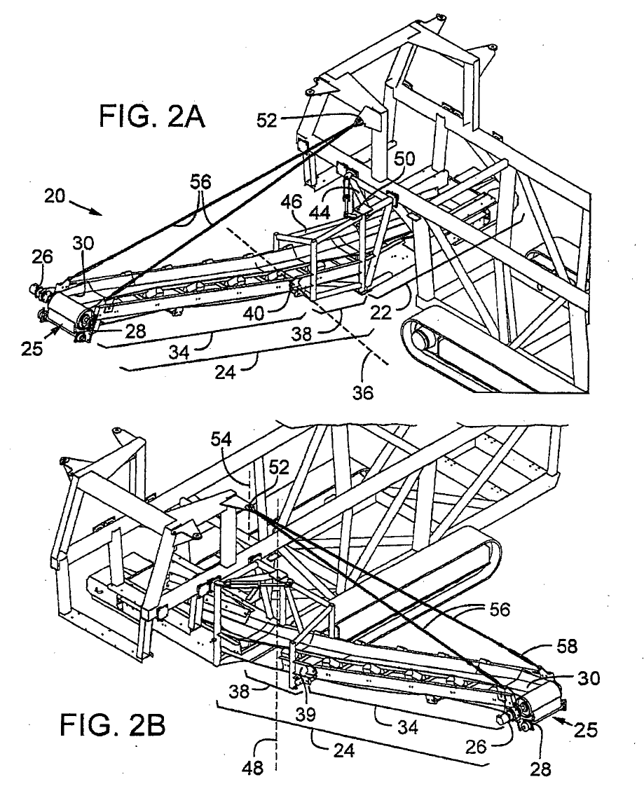

FIGS. 2A and 2B illustrate enlarged perspective views of a folding conveyor in accordance with embodiments of the present invention. Conveyor 20 may include a first conveyor section 22 configured to receive the material to be conveyed from the mobile processing unit 10. In some embodiments, first conveyor section 22 may be positioned completely or partially within and/or under the screen decks 16.

Conveyor 20 may also include second conveyor section 24 which may be, for example, generally the portion of the conveyor that protrudes outwardly from the mobile processing unit while in the operational configuration. In one embodiment, second conveyor section 24 may include an outer end 25 from which the material being conveyed is generally discharged. Outer end 25 may include a drive motor 26 and a drive pulley 28 configured to drive a conveyor belt 30. When in operation, material may be deposited onto the belt 30 of conveyor 20 at the first conveyor section 22 and conveyed to the second conveyor section 24 towards the outer end 25 for stockpiling or further processing of the aggregate material.

In one embodiment, the second conveyor section 24 may include an outer section 34 that, when in the processing configuration, may protrude substantially outward from the mobile processing unit 10. Conveyor 20 may also have an interim section 38 positioned between the outer section 34 and the first conveyor section 22. Outer section 34 may be pivotally connected to the interim section 38 at a second hinge point 40. Coupling outer section 34 to interim section 38 at second hinge point 40 may allow the outer section 34 to pivot about second axis 36, which as shown in the example embodiment is substantially horizontal. In other embodiments, the position of the hinge axis can vary from vertical and horizontal to create a desired folding action.

Conveyor 20 may be at least partially coupled to and/or supported by a frame that may be coupled to the mobile processing unit. In one embodiment, the frame may include a first frame section 44 and a second frame section 46. First frame section 44 may be secured to the mobile processing unit and coupled to conveyor 20. In some embodiments, conveyor 20 may at least partially pass under, through, and/or over the frame. First frame section 44 may also be coupled to and/or support a portion of the first conveyor section 22.

Second frame section 46 may be pivotally connected to the first frame section 44 at a first hinge point 50. Through the interconnection at first hinge point 50, second frame section 46 may generally pivot about first axis 48, which as shown in the illustrated embodiment may be substantially vertical. In one embodiment, the second frame section 46 may be operationally coupled to the interim section 38, such that when the second frame section 46 pivots about first axis 48, the interim section 38 of conveyor 20 also may pivot about substantially the first axis 48. With the outer section 34 hingedly coupled to interim section 38 such that pivotal movement of outer section 34 is permitted with respect to interim section 38, pivoting of the interim section 38 about first axis 48 also may cause the outer section 34 to pivot substantially about first axis 48.

In one embodiment, second frame section 46 and first frame section 44 may be configured to allow second frame section 46 to pivot enough to cause the outer section 34 and interim section 38 to pivot the point where the conveyor 20 is in a travel configuration, i.e., the conveyor 20 is folded to reduce the overall width of the mobile processing unit. Desired folding of the conveyor 20 may be accomplished in a variety of ways, including, for example, configuring the first and second frame sections to have bracing that does not interfere with bracing from the other frame section, or offset such that potentially interfering bracing would be above or below other such bracing.

In one embodiment, the hinge point 50 and first axis 48 may be positioned a sufficient distance from the side of the mobile processing unit to allow the outer section 34 to fold substantially parallel with the length of the mobile processing unit. In such an embodiment, the first frame section 44 may be extended outward from the mobile processing unit a sufficient distance, thus moving the hinge point 50 and first axis 48 outward, to allow the second conveyor section 24 to fold substantially parallel with the mobile processing unit. In other embodiments, the positioning of the hinge point 50 and first axis 48 may be selected based on the desired folded configuration of the conveyor 20.

In one embodiment, as the second conveyor section 24 and interim section 38 fold inward, the conveyor belt 30 may fold as the linear distance between the first end and the second end is reduced due to the conveyor folding action. Such a folding action may help to reduce the tendency for belt sag, and prevent unnecessary wear on the belt due to dragging on the ground, for example.

The conveyor 20 may be configured to fold either forward or rearward with respect to the mobile processing unit. Depending on which way the conveyor is configured to fold, the inner portion of the interim section 38 may be adapted to provide some support for conveyor belt 30, but not conflict with the first frame section 44 or the mobile processing unit itself during the folding operation. In one embodiment, the inner portion may include an abbreviated side support section 39, which may both facilitate folding of the second conveyor section 24 without undue obstruction, as well as facilitate the folding of the conveyor belt 30.

In some embodiments, one or more support members 56 may be coupled to the mobile processing unit and configured to help support the outer section 34 of the second conveyor section 24. Support members 56 may be attached to the mobile processing unit at an offset pivot 52, which, in some embodiments, may be located above the first and second frame sections 44 and 46. In other embodiments, the pivot point may be located in the same plane or below the first and second frame sections. The other end of the support members may be coupled to the conveyor at a point between the second frame section 46 and the outer end 25. The support members may be of a rigid nature such as steel rod, angle iron, or the like, or may be of a flexible nature such as cable, chain, and the like.

The support members 56 may be adjustable for a variety of reasons, including, but not limited to maintaining tension in the support members and controllably raising and lowering the outer end of the conveyor. In one embodiment, an adjustable device may be used that includes positioning one or more turnbuckles in the support members to adjust their length. Another example of an adjustment mechanism that may control the length of support members 56 is to mount one or more winches at the offset pivot point that may allow for length manipulation of flexible support members in order to control the raising and lowering of the outer section 34 about second axis 36. In another embodiment, a rigid support member may be used, and the adjustable device may include one or more actuators such as hydraulic cylinders that controllably manipulate the pivotal movement of the outer section 34 about second axis 36. In other embodiments, a combination of rigid and flexible materials may be used for support members 56.

In one embodiment, the offset pivot 52 may be positioned such the offset pivot axis 54 is substantially parallel with first axis 48, but offset such that it intersects the center of the conveyor 20 in the operational configuration, as well as intersect the center of the conveyor 20 while in the travel configuration. Positioning the offset pivot 52 in such a manner may allow the support members to maintain tensioned engagement and support with both sides of the conveyor 20, while allowing the outer section 34 to pivot downward a sufficient distance to avoid interference with other parts of the mobile processing unit as the conveyor 20 is being folded into the travel configuration.

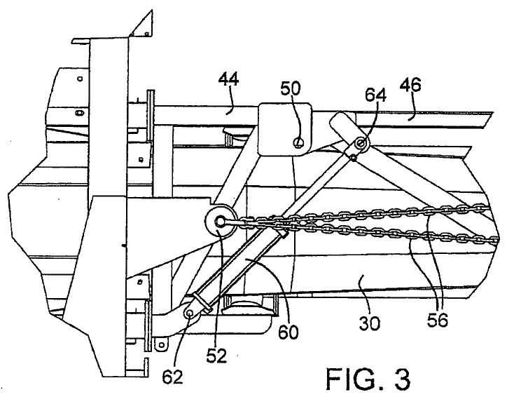

FIG. 3 is an exploded plan view of a folding conveyor in accordance with an embodiment of the present invention. Offset pivot 52 may be positioned above first frame section 44 and centered above conveyor belt 30. Support members 56 may be pivotally coupled to offset pivot 52. Second frame section 46 may be pivotally coupled to first frame section 44 at first hinge point 50.

In other embodiments, however, the offset pivot point may be positioned at different points relative to the first axis 48 and the mobile processing unit, depending on desired folding and operational characteristics of the conveyor. For example, the offset pivot point may be moved outward from the center point of the conveyor when in the folded position to urge the outer end of the second conveyor section 24 to lower more when in the folded travel configuration. In other embodiments, the position of the pivot point may be pivotally raised and lowered above the frame as desired, in order to, for example, alter the supporting characteristics of the support members attached thereto. Further, depending on the length and amount of support necessary, the second end of the support members may couple to the conveyor at various preselected locations.

In some embodiments, an actuation device may be responsible for controlling the folding of the conveyor 20. In one embodiment, hydraulic cylinder 60 may have a first end 62 attached to the mobile processing unit and/or frame first section 44, and a second end 64 operationally coupled to the second frame section 46. Actuation of hydraulic cylinder 60 (retraction thereof) may cause second frame section 46 to pivot inward toward the mobile processing unit and thus urge in the second conveyor section 24 to fold toward the travel position. Likewise, actuation of the hydraulic cylinder 60 (extension thereof) may cause the second conveyor section 24 to pivot outwardly toward the operational configuration.

Hydraulic cylinder 60 may be controllably actuated to partially cause the second frame section to pivot about axis 48, which may enable partial redirection of the material being conveyed. In other embodiments, a variety of actuation devices may be used to induce folding of the conveyor 20, including, but not limited to pneumatic cylinders, gear drive motors, and other operational devices.

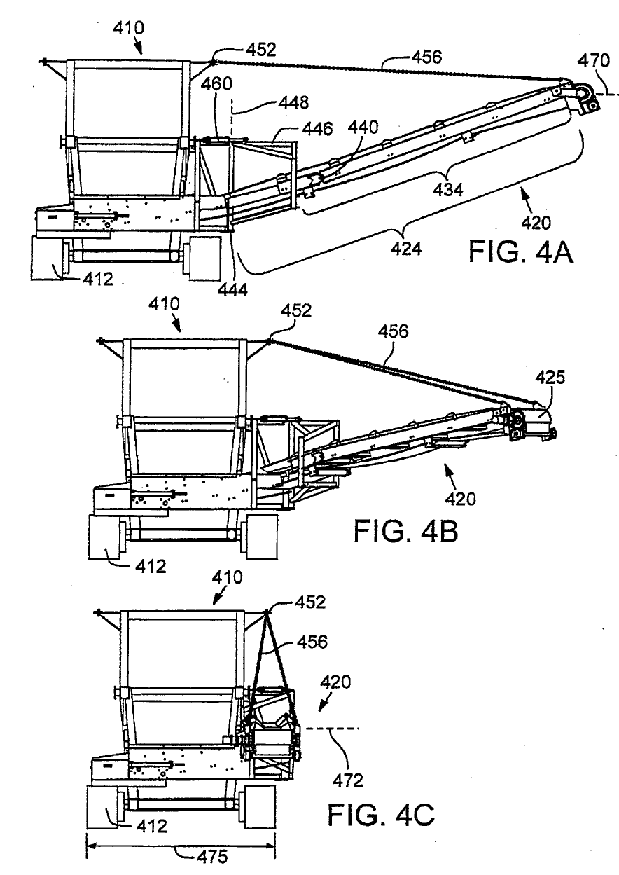

FIGS. 4A-4C illustrate end views of a mobile processing unit folding from the operational configuration to the travel configuration in accordance with embodiments of the present invention. Referring to FIG. 4A, mobile processing unit 410 may be movably mounted on tracks 412 and include at least one side discharge conveyor 420 in accordance with embodiments of the present invention. As illustrated, side discharge conveyor 420 is the operational configuration with the outer end 425 of the second conveyor section 424 at a first elevation 470. Mobile processing unit 410 may include a first frame section 444, and a second frame section 446 that is pivotally coupled thereto about first axis 448. Support members 456 may be adapted to couple to an offset pivot 452 with an outer section 434 of the second conveyor section 424 and help provide support and/or movement control.

To initiate folding of conveyor 420, cylinder 460 may retract, thus urging outer frame section 446 to pivot about first axis 448. FIG. 4B illustrates the side discharge conveyor 420 in the process of being folded to the travel configuration. By virtue of the positioning of the offset pivot 452, as the second conveyor section 424 begins to fold, the outer end 425 may pivot about hinge point 440. Such a lowering of the outer end may be useful in avoiding other components of the mobile processing unit as it moves to the travel position. The position the offset pivot point may be selected as desired to increase or decrease the amount of pivotal movement of the outer end 425.

As illustrated in FIG. 4C, the conveyor is in the travel configuration, with the second conveyor section being positioned substantially parallel to the mobile processing unit 410, and thus in a travel configuration. In the travel configuration, the outer end 425 has lowered from the first elevation 470 to a second elevation 472. Further, the overall width 475 of the mobile processing unit has been reduced such that it may fit within a certain width specification or requirement. One such specification may be the width restriction requirements imposed by the United States Department of Transportation for vehicles traveling on US highways.

While the illustrated embodiments include a second conveyor section having an outer section and an interim section, other embodiments may not include the interim section. In such embodiments, the second conveyor section may be coupled to a second frame portion and adapted to pivot about a first axis with the second frame section, and may also be adapted to pivot about a second axis with respect to the second frame section. In other embodiments, the first frame section may be an integral part of the mobile processing unit structure or may be a separate structure that may be coupled there to.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A folding conveyor adapted for use on an aggregate processing unit, comprising:
a first conveyor section and a second conveyor section, the first conveyor section adapted to receive aggregate material from the processing unit and convey the material to the second conveyor section;
a frame coupled to the processing unit and configured to at least partially couple to the conveyor, the frame including a first frame section and a second frame section, the second frame section pivotally coupled to the first frame section about a first axis, the second frame section being coupled to the second conveyor section such that the second frame section may pivot about the first axis;
an offset pivot; and
at least one support member adapted to couple the offset pivot with the second conveyor section.

2. The folding conveyor of claim 1, wherein the second conveyor section includes an outer section and an interim section, the interim section being coupled to the second frame section and pivotally coupled to the outer section along a second axis to allow movement of the outer section relative to the interim section.

3. The folding conveyor of claim 2, wherein the at least one support member is coupled to the outer section of the second conveyor section.

4. The folding conveyor of claim 1, wherein the at least one support member is controllably adjustable to manipulate the pivotal movement of the second conveyor section about the second axis.

5. The folding conveyor of claim 4, wherein the at least one support member is a flexible support member.

6. The folding conveyor of claim 5, wherein the at least one support member is operably coupled to a winch in order to controllably manipulate the pivotal movement of the second conveyor section about the second axis.

7. The folding conveyor of claim 5, wherein the at least one support member is operably coupled to a turnbuckle in order to controllably manipulate the pivotal movement of the second conveyor section about the second axis.

8. The folding conveyor of claim 4, wherein the at least one support member is an adjustable rigid support member.

9. The folding conveyor of claim 8, wherein the at least one support member is an actuator that is controllably adjustable to manipulate the rotational movement of the second conveyor section about the second axis.

10. The folding conveyor of claim 1, wherein the offset pivot is positioned at a point aligned with an offset axis that passes through a center point of the conveyor while in both an operational extended position and a folded travel position.

11. The folding conveyor of claim 1, further comprising an actuation device coupled to the processing unit and further operationally coupled to the second frame section, the actuation device adapted to cause the second frame section to controllably pivot about the first axis.

12. The folding conveyor of claim 11, wherein the actuation device is an actuator having a first end coupled to the first frame section and a second end coupled to the second frame section.

13. The folding conveyor of claim 1, further coupled to a mobile rock crushing unit, wherein the conveyor has an extended operational position configured to move aggregate to a discrete location and a folded travel position adapted to allow the mobile rock crushing unit to fit within a desired width.

14. The folding conveyor of claim 1, further coupled to a mobile rock screening unit, wherein the conveyor has an extended operational position configured to move rock to a discrete location and a folded travel position adapted to allow the mobile rock screening unit to fit within a desired width.

15. An aggregate processing unit, comprising:
an aggregate processing portion;
a travel mechanism adapted to allow the aggregate processing unit to move from one point to another point;
at least one conveyor adapted to move material from the aggregate processing portion to a discrete location, the at least one conveyor including a first conveyor section and a second conveyor section, the first conveyor section adapted to receive aggregate material from the aggregate processing portion and convey the material to the second conveyor section, the second conveyor section including an outer section and an interim section, the interim section being pivotally coupled to the outer section along a second axis to allow pivotal movement of the outer section about the second axis;
a frame coupled to the processing unit, the frame including a first frame section and a second frame section, the second frame section pivotally coupled to the first frame section about a first axis such that the second frame section may pivot about the first axis, the second frame section being coupled to the interim section of the second section;
an offset pivot; and
at least one support member adapted to couple the offset pivot with the outer section of the second conveyor section.

16. The aggregate processing unit of claim 15, wherein the offset pivot is aligned with an offset axis that passes through a center point of the conveyor while in both an operational extended position and a folded travel position.

17. The aggregate processing unit of claim 15, wherein the offset pivot is adapted to be moved to different positions above the frame to alter the amount and characteristic of the pivotal movement of the outer section of the second conveyor section.

18. The aggregate processing unit of claim 15, further comprising an actuation device coupled to the processing unit and further operationally coupled to the second frame section, the actuation device adapted to cause the second frame section to controllably pivot about the first axis.

19. The aggregate processing unit of claim 18, wherein the actuation device is a hydraulic cylinder having a first end coupled to the first frame section and a second end coupled to the second frame section, such that retraction and extension of the hydraulic cylinder will cause the second conveyor section to pivot about the first axis to fold to a travel position and extend to an operational position, respectively.

20. The aggregate processing unit of claim 15, wherein the aggregate processing portion is either a screen or a rock crusher.

21. The aggregate processing unit of claim 15, wherein the at least one support member is controllably adjustable to manipulate the pivotal movement of the second conveyor section.

22. The folding conveyor of claim 21, wherein the at least one support member is a flexible support member.

23. The folding conveyor of claim 15, wherein the first axis is substantially vertical and the second axis is substantially horizontal.

24. A folding conveyor adapted for use on an aggregate processing unit, comprising:
a first conveyor section adapted to receive aggregate material from the processing unit and convey the material to a second conveyor section; and
a support structure coupled to the processing unit, the support structure including a first portion and a second portion that is pivotally coupled to the first portion about a first axis, the second portion coupled to the second conveyor section such that the second frame section may pivot about the first axis.

25. The folding conveyor of claim 24, further comprising an offset pivot and at least one support member adapted to couple the offset pivot with the second conveyor section.

26. The folding conveyor of claim 25, wherein the second conveyor section is movably coupled to the second portion, and wherein the at least one support member is controllably adjustable to manipulate movement of the second conveyor section with respect to the second portion.

27. The folding conveyor of claim 25, wherein the second conveyor section includes an outer section and an interim section, the interim section being coupled to the second frame section and pivotally coupled to the outer section along a second axis to allow movement of the outer section relative to the interim section.

28. The folding conveyor of claim 25, wherein the offset pivot is positioned at a point aligned with an offset axis that passes through a center point of the conveyor while in both an operational extended position and a folded travel position.

29. The folding conveyor of claim 24, further comprising an actuation device coupled to the processing unit and further operationally coupled to the second portion of the support structure, the actuation device adapted to cause the second frame section to controllably pivot about the first axis.
